(19) United States
(12) Patent Application Publication
(10) Pub. No.: US 2014/0005090 A1
(43) Pub. Date: Jan. 2, 2014

(54) STABILIZATION OF SURFACTANTS AGAINST OXIDATIVE ATTACK

(71) Applicants: David J. Bonislawski, Powder Springs, GA (US); David C. Lovetro, Marietta, GA (US); Lauren Schneidewind, Atlanta, GA (US)

(72) Inventors: David J. Bonislawski, Powder Springs, GA (US); David C. Lovetro, Marietta, GA (US); Lauren Schneidewind, Atlanta, GA (US)

(21) Appl. No.: 14/004,592

(22) PCT Filed: Mar. 8, 2012
(86) PCT No.: PCT/EP12/53950

§ 371 Date: Sep. 11, 2013

Related U.S. Application Data
(60) Provisional application No. 61/451,829, filed on Mar. 11, 2011.

(51) Int. Cl. C11D 3/395

(52) U.S. Cl. CPC C11D 3/3951
USPC 510/108; 252/186.25; 252/186.29

(57) ABSTRACT

The present invention is directed to stabilized surfactant containing solutions, stabilized or inhibited against oxidative attack, comprising an amphiphilic antioxidant component.

### FIELD OF THE INVENTION

The field of the invention relates to stabilization of solutions containing surfactants against oxidative attack. In one aspect, it relates to peroxide cleaning solutions containing a peroxide component, an organic surfactant and stabilizers and processes for preparing stabilized cleaning formulations.

### BACKGROUND OF THE INVENTION

Stabilizers are normally added to hydrogen peroxide solutions to combat decomposition of the hydrogen peroxide due to trace impurities, mainly dissolved metals. These compounds are usually sequestering agents and can take many forms. Many types of compounds have been used to fill this function, such as diols, quinones, stannate salts, pyrophosphates, various aromatic compounds and amino carboxylic acids salts. However, many of the previously suggested compounds have various issues and challenges associated with them, such as toxicity, environmental impact and poor performance.

Examples of specific compounds that have been suggested for use in solutions to protect against hydrogen peroxide decomposition include sodium phenolsulfate; sodium stannate; N,N-lower alkyl aniline, sulfamic acid, sulfolane, and dinormal lower alkyl sulfones and sulfoxides; phosphonic acids and their salts; acrylic acid polymers; polyphosphates; polyamino polyphosphonic acids and/or their salts; and specific combinations (or blends) of such compounds. However, in addition to toxicity and environmental impact concerns, many of these suggested compounds or blends have other drawbacks. For example, use of the specific stabilizer(s) either require specific conditions to provide adequate hydrogen peroxide stability, such as specific pH levels, e.g., acidic conditions, or relatively low hydrogen peroxide concentrations, or have poor stability performance. The poor stability performance can either be poor stability performance generally or poor stability performance in specific formulations that contain other destabilizing components, e.g., surfactants.

In addition, hydrogen peroxide has been used widely as an ingredient in various solutions containing organic components, such as organic surfactants, e.g., in cleaning solutions. Many such cleaning solutions require a controlled pH and various other ingredients, which can have a destabilizing effect on the hydrogen peroxide, to achieve the desired cleaning performance.

Even with relatively good hydrogen peroxide stability as a result an appropriate sequestering agent, e.g., phosphonic acid based sequestering agents, there exists a need to provide peroxide based solutions containing organic components which have improved stability.

### SUMMARY OF THE INVENTION

It has been found that even with sequestering agents many oxidant (e.g., peroxide) based cleaning solutions containing organic surfactants experience a downward pH drift over time and possibly an unacceptable short shelf life. It is believed that such a pH drift is a result of destabilization of the organic surfactant as a result of oxidative attack by the oxidant. Further, it is believed that the destabilization of the organic surfactant results in a reduction in the cleaning performance normally provided by un-reacted surfactant.

In one aspect, the present invention is directed to surfactants stabilized against oxidative attack, which are suitable for use with oxidants. In one embodiment, the invention is directed to a stabilized surfactant composition, stabilized or inhibited against oxidative attack, comprising a surfactant component and an amphiphilic antioxidant component. In an embodiment of the invention, the stabilized surfactant composition is included in a cleaning solution (or formulation) containing an oxidant component, e.g., hydrogen peroxide solution.

In another aspect, the invention is directed to a stabilized oxidant composition comprising an oxidant and an amphiphilic antioxidant component. In one embodiment, the stabilized oxidant composition further comprises a sequestering agent stabilizer, e.g., a phosphonic acid based sequestering agent. In an embodiment, the oxidant is a peroxide, e.g., hydrogen peroxide. In an embodiment of the invention, the stabilized oxidant composition is combined with at least one suitable surfactant and, optionally, other common components (e.g., used in cleaning formulations) to make a cleaning solution with the surfactant protected against oxidative attack.

In another aspect, the invention is directed to a peroxide based cleaning composition, stabilized against oxidative attack of a surfactant, containing a peroxide component (e.g., hydrogen peroxide), a surfactant and stabilizers.

In one embodiment, the peroxide based cleaning composition comprises: (1) an aqueous peroxide composition that comprises (a) a peroxide component, (b) a peroxide stabilizer component, (c) an amphiphilic antioxidant component, and (d) water; and (2) a surfactant component.

In one embodiment, the peroxide based cleaning composition comprises: (1) an aqueous peroxide composition that comprises (a) a peroxide component, (b) a peroxide stabilizer component, and (c) water; and (2) a stabilized surfactant composition that comprises (a) a surfactant component and (b) an amphiphilic antioxidant component.

In one embodiment, the peroxide component is hydrogen peroxide. In an embodiment, the peroxide stabilizer component is a complexing agent based on phosphonic acid, its salts or degradation products thereof.

In one embodiment, the peroxide composition comprises: (a) hydrogen peroxide in an amount from about 20 to about 70 wt %, based on the peroxide composition, (b) at least one diphosphonic acid compound, its salts or degradation products thereof in an amount from about 10 to about 60 wt %, based on the amount of hydrogen peroxide, and (c) water. In one embodiment, the diphosphonic acid compound is 1-hydroxyethylidine-1,1-diphosphonic acid (HEDP). In one embodiment, the peroxide composition further comprises: (d) an amphiphilic antioxidant component.

In embodiments of the invention, the surfactant component comprises non-ionic, amphoteric, anionic or cationic surfactants. Non-ionic surfactants are preferred and may, for example, include one or more of ethoxylated and/or propoxylated fatty acids, alcohols, amines or amides, preferably comprising from 1 to 12 most preferably from 4 to 8 mols ethylene oxide and/or propylene oxide per mol acid, alcohol, amine or amide. Preferably the acid, alcohol or amide comprises from 7 to 15, most preferably from 9 to 11 carbon atoms. Useful non-ionic surfactants can be high foaming such as an ethoxylated alcohol containing 11 carbon atoms and 8 ethylene oxides, or low foaming such as a narrow range ethoxylated alcohol containing 9 carbon atoms and 6 ethylene oxides. Further surfactants may include alkyl polyglucosides and other carbohydrate derivatives.

In one embodiment, the surfactant is a narrow range non-ionic with either straight or branched hydrophobes. Non-limiting examples are Berol® 260, Berol® 266, Berol® 505 and Berol® 508 (all from AkzoNobel).

In an embodiment, the amphiphilic antioxidant component comprises at least one amphiphilic antioxidant and at least one antioxidant booster. In one embodiment, the at least one amphiphilic antioxidant is present in an amount from about 0.5 to about 20 wt %, or about 1 to about 15 wt %, about 1 to about 10 wt %, or about 1.5 to about 6 wt %, based on the amount of surfactant.

In one embodiment, the at least one amphiphilic antioxidant includes alpha-tocopherol. In another embodiment, the amphiphilic antioxidant component comprises at least two amphiphilic antioxidants, wherein alpha-tocopherol is the primary (i.e., majority) amphiphilic antioxidant.

In one embodiment of the invention, the molar ratio of amphiphilic antioxidant to antioxidant booster is at least 1:1. In an embodiment, the antioxidant booster includes at least one hydrophilic compound having antioxidant or radical scavenging properties. In embodiments, the ratio of amphiphilic antioxidant to antioxidant booster is at least 1.1:1, or at least 2:1, or at least 3:1, or at least 5:1, based on the molecular weight (i.e., molar ratio) of the materials. In embodiments of the invention, the antioxidant booster is chosen from lipoic acid, caffeic acid, cinnamic acid, nicotinic acid, picolinic acid, ferulic acid, coumaric acid, derivatives thereof, and combinations thereof. In one embodiment, the booster is picolinic acid.

The solution, e.g., cleaning solution, can also include other additives selected from the group consisting of builders, fragrances, colorants and combinations thereof. In one embodiment, the builders are selected from the group consisting of organic and inorganic salts, such as but not limited to EDTA, GLDA, sodium chloride, polyphosphates and the like.

In embodiments of the invention, the pH of the peroxide containing solution is in the range of at least 4 to about 11, more preferably at least 4 to about 10 and most preferably about 4 to about 9.5. In embodiments, hydrogen peroxide is present in an amount from about 0.1 to about 20 wt %, or about 0.3 to about 15 wt %, or about 0.5 to about 8 wt %, based on the entire peroxide solution. In embodiments, the peroxide stabilizer is present in an amount sufficient to provide the solution with a hydrogen peroxide stability of at least about 50%, more preferably at least about 60%, and most preferably at least about 65%, after 16 hours at about 97° C.

In embodiments, surfactant is present in an amount from about 0.04 to about 10 wt %, or about 0.1 to about 5 wt %, or about 0.5 to about 2 wt %, based on the entire peroxide containing solution. In embodiments, the amphiphilic antioxidant component is present in an amount sufficient to provide the peroxide solution with pH stability decrease (total pH drop) of less than about 2, or less than about 1.5, or less than about 1, after 24 hours at about 94° C.

In one embodiment, the peroxide based composition comprises: (1) hydrogen peroxide in an amount of 0.1 to about 8 wt %, based on the total composition; (2) HEDP, its salts or degradation products thereof in an amount from about 10 to about 60 wt %, based on the amount of hydrogen peroxide; (3) a surfactant in an amount of 0.1 to about 2 wt %, based on the total composition; and (4) at least one amphiphilic antioxidant molecule (as described herein) in an amount from about 0.5 to about 20 wt %, based on the amount of surfactant, and at least one antioxidant booster (as described herein), wherein the molar ratio of amphiphilic antioxidant molecule to antioxidant booster is at least 1:1. In one embodiment, the composition is a cleaning composition, e.g., a fabric cleaner or a carpet cleaner. In another embodiment, the composition is a cleansing or treating composition for cleansing or treating a plant or animal, e.g., for use in cleansing or treating a wound on an animal, such as a human.

In one aspect, the invention is directed to a method for preparing a stabilized peroxide based solution, which comprises: 1) preparing a stabilized surfactant composition by combining a surfactant component with an amphiphilic antioxidant component; 2) combining the stabilized surfactant composition with a peroxide composition; 3) and adding an alkali agent (e.g., caustic) to the combination from step 2) in an amount to adjust the pH to a value of at least 6. In one embodiment, the amphiphilic antioxidant component comprises at least one amphiphilic antioxidant molecule and at least one antioxidant booster, wherein the amphiphilic antioxidant molecule and antioxidant booster are added separately to surfactant component. In one embodiment, the amphiphilic antioxidant molecule and antioxidant booster are first combined prior to adding to the surfactant component. In one embodiment, the peroxide composition comprises hydrogen peroxide, a phosphonic acid based sequestering agent, e.g., HEDP, and water. The amounts of each of the different components can be as specified herein in the specification.

In another aspect, the invention is directed to an article that comprises a substrate having the compositions according to the invention absorbed onto or into the substrate. In embodiments of the invention, the article can be a sponge, a cleaning pad, a bandage, or a fibrous woven or non-woven sheet (or other article).

Additional objects, advantages and novel features will be apparent to those skilled in the art upon examination of the description that follows.

### BRIEF DESCRIPTION OF THE DRAWINGS

FIG. 1 is a graph showing the effect of the invention on pH drop.

FIG. 2 is a graph showing the effect of the invention on peroxide stability.

FIG. 3a is a graph showing the effect of the invention on turbidity of a cleaning solution.

FIG. 3b is a graph showing the effect of the invention on peroxide stability.

FIG. 4a is a graph showing the effect of the invention on pH drop.

FIG. 4b is a graph showing the effect of the invention on peroxide stability.

FIG. 5 is a graph showing the effect of the invention on pH drift.

FIGS. 6a-c are photographs showing the effect of the invention on cleaning ability.

FIG. 7 is a graph showing the effect of the invention on cleaning efficiency.

FIG. 8 is a graph showing the effect of the invention on pH drift.

FIG. 9 is a graph showing the effect of the invention on pH drift.

FIG. 10 is a graph showing the effect of the invention on pH drift.

### DETAILED DESCRIPTION OF THE INVENTION

Without being bound by any particular theory, it is believed that over time and at ambient conditions of temperature and humidity that oxidative attack on the surfactant component takes place in formulations containing both hydrogen peroxide and surfactant. The reaction pathway is thought to proceed through two or more steps culminating in the formation of an organic acid species which results in the drop of pH of the formulation. The first step of this process, however, is thought to start with oxidative attack on the surfactant in the formulation. The by-products of this first reaction are thought to provide the reactants for the next step in the continued oxidation of organics that result in acid formation. The first indication of this attack is cloudiness that develops as a result of the change in the surfactant solubility, which is quantifiable via turbidity measurements. Some small amount of surfactant may be oxidized and not result in a change in clarity at room temperature but does result in a change in the cloud point temperature of the solution. A cloudy solution indicates that surfactant micelles are no longer present and therefore cleaning performance has degraded. Preventing this cloudiness from forming and inhibiting the drop in pH are desirable in order to preserve the performance of a cleaning solution.

In one aspect, the present invention is directed to surfactants stabilized against oxidative attack, which are suitable for use in oxidant based solutions. In one embodiment, the invention is directed to a stabilized surfactant composition, stabilized or inhibited against oxidative attack, comprising a surfactant component and an amphiphilic antioxidant component. In an embodiment of the invention, the stabilized surfactant composition is included in a cleaning solution (or formulation) containing an oxidant component, e.g., hydrogen peroxide solution.

In another aspect, the invention is directed to a stabilized oxidant composition comprising an oxidant and an amphiphilic antioxidant component. In one embodiment, the stabilized oxidant composition further comprises a sequestering agent stabilizer, e.g., a phosphonic acid based sequestering agent, such as HEDP. In an embodiment, the oxidant is a peroxide, e.g., hydrogen peroxide. In an embodiment of the invention, the stabilized oxidant composition is combined with at least one suitable surfactant and, optionally, other common components (e.g., components used in cleaning formulations) to make a solution with the surfactant protected against oxidative attack.

In another aspect, the invention is directed to a peroxide based cleaning composition, stabilized against oxidative attack of a surfactant, containing a peroxide component, a surfactant and stabilizers. In one embodiment, the peroxide is hydrogen peroxide.

The hydrogen peroxide used to prepare the cleaning composition can be in the form of a stabilized hydrogen peroxide solution, which solution comprises a relatively high concentration of hydrogen peroxide, e.g., at least about 20 wt % hydrogen peroxide, based on the stabilized hydrogen peroxide solution, and a sequestering agent, e.g., a phosphonic acid based sequestering agent, such as HEDP. An example of a commercially available stabilized hydrogen peroxide solution is Peroxy-Blend® PB-30 (from AkzoNobel). In one embodiment, the stabilized hydrogen peroxide solution is combined with an amphiphilic antioxidant component prior to being combined with a surfactant. In another embodiment, a surfactant is combined with an amphiphilic antioxidant component prior to being combined with the stabilized hydrogen peroxide solution.

In one embodiment, the peroxide based cleaning composition comprises: (1) an aqueous peroxide composition that comprises (a) a peroxide component, (b) a peroxide stabilizer component, (c) an amphiphilic antioxidant component, and (d) water; and (2) a surfactant component.

In one embodiment, the peroxide based cleaning composition comprises: (1) an aqueous peroxide composition that comprises (a) a peroxide component, (b) a peroxide stabilizer component, and (c) water; and (2) a stabilized surfactant composition that comprises (a) a surfactant component and (b) an amphiphilic antioxidant component.

In one embodiment, the peroxide stabilizer component comprises a phosphonic acid based stabilizer. By the term “phosphonic acid based stabilizer” is intended to include compounds having at least one phosphonic acid group in its structure, including compounds in their acid form or salts thereof, as well as decomposition products of such compounds.

The phosphonic acid based stabilizer can include commercially available compounds which include a phosphonic acid group in their structure. Non-limiting examples of such stabilizers include 1-hydroxy-1,1-ethylidene diphosphonate commercially available as DEQUEST 2010, amino tri(methylene-phosphonic acid) available as DEQUEST 2000 and DEQUEST 2000LC; amino tri(methylene-phosphonic acid)pentasodium salt available as DEQUEST 2006; 1-hydroxyethylene-1,1,-diphosphonic acid commercially available as DEQUEST 2010; 1-hydroxyethylene-1,1,-diphosphonic acid tetrasodium salt available as DEQUEST 2016 and DEQUEST 2016D; ethylene diamine tetra(methylene phosphonic acid) available as DEQUEST 2041; ethylene diamine tetra(methylene phosphonic acid)pentasodium salt available as DEQUEST 2046; hexamethylenediamine tetra(methylene phosphonic acid) potassium salt available as DEQUEST 2054; diethylenetriamine penta(methylene phosphonic acid) available as DEQUEST 2060S; diethylenetriamine penta(methylenephosphonic acid)trisodium salt available as DEQUEST 2066A; diethylenetriamine penta(methylenephosphonic acid)pentasodium salt available as DEQUEST 2066; diethylenetriamine penta(methylene phosphonic acid)pentasodium salt commercially available as DEQUEST 2066C2; bis-hexamethylene triaminepenta(methylenephosphonic acid) chloride salt commercially available as DEQUEST 2090A; tetrasodium salt of 1-hydroxy ethyliden (1,1-diphosphonic acid) commercially available as DEQUEST SPE 9528, as well as other materials sold under the DEQUEST tradename, particularly DEQUEST 2086, DEQUEST 3000S, as well as DEQUEST 6004.

The peroxide composition is preferably added to the solution that will also contain an organic surfactant (e.g., a cleaning solution) in an amount to provide a cleaning solution having an initial hydrogen peroxide concentration of from about 0.1 to about 20 wt %, more preferably about 0.3 to about 15 wt %, and most preferably about 0.5 to about 8 wt %, based on the entire cleaning solution.

The cleaning solution is preferably prepared by combining the hydrogen peroxide solution with at least one surfactant, water and an alkali agent in an amount to bring the pH of the cleaning solution to at least 6.

It is contemplated that the surfactant can be of a type selected from the group consisting nonionic, cationic, anionic, amphoteric, zwitterionic, and combinations thereof. The surfactant is suitably present in an amount for about 0.1 to about 15 wt %, preferably about 0.3 to about 10 wt %, more preferably about 0.5 to about 8 wt %, based on the total weight of the solution, e.g., the cleaning solution.

In one embodiment, the surfactant is preferably of a type selected from the group consisting of nonionic, cationic and combinations thereof. Generally any nonionic surfactant material may be used in the inventive compositions. Practically any hydrophobic compound having a carboxy, hydroxy, amido, or amino group with a free hydrogen attached to the nitrogen can be condensed with an alkylene oxide, especially ethylene oxide or with the polyhydration product thereof, a polyalkylene glycol, especially polyethylene glycol, to form a water soluble or water dispersible nonionic surfactant compound. By way of non-limiting examples, suitable nonionic surfactants which may be used in the present invention include polyalkylene oxide condensates of alkyl phenols; the condensation products of aliphatic alcohols with an alkylene oxide, e.g., an ethylene oxide; primary and secondary linear and branched alcohol ethoxylates; and alkoxy block copolymers, and in particular, compounds based on ethoxy/propoxy block copolymers. Examples of suitable commercially available nonionic surfactants include surfactants sold under the trade names Berol® 260, Berol® 505, and Berol® 508 (all from Akzo Nobel).

A surfactant can be considered cationic if the charge on the hydrophilic portion of the molecule is positive. Surfactants in which the hydrophile carries no charge unless the pH is lowered close to neutrality or lower, but which are then cationic (e.g. alkyl amines), are also included in this group. Suitable cationic surfactants can be easily determined by one skilled in the art. By way of non-limiting examples, suitable cationic surfactants can include compounds containing at least one long carbon chain hydrophobic group and at least one positively charged nitrogen. In addition, suitable cationic surfactants may contain complex linkages having more than one cationic nitrogen atom. The cationic surfactant can include a quaternary ammonium surfactant, such as biocidal quaternary ammonium compounds, such as tallow quaternary ammonium surfactant, such as a tallow amine ethoxylate quaternary ammonium compound. One cationic surfactant suitable for the present invention is sold under the trade name Berol® 563SA (from Akzo Nobel). Blends of nonionic and cationic surfactants are also contemplated. Examples of such blends include surfactants sold under the trade names Berol® 226SA and Berol® EZ-1 (from Akzo Nobel).

In another embodiment, the surfactant is an anionic surfactant. Generally any anionic surfactant material may be used in the inventive compositions. By way of non-limiting example, suitable anionic surfactants include: alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds can include a carbon chain containing 12 to 20 carbon atoms. Examples of specific anionic surfactants suitable for the invention include sodium xylene sulfonate surfactants, as well as naphthalene sulfonate surfactants sold under the trade names Petro BA, Petro AA and Petro ULF (from AkzoNobel). In one embodiment, the anionic surfactant has a phenyl sulfonic structure, such as Petro AA. In another embodiment the anionic surfactant has an alkyl sulfonate structure such as NAS-8 (from AkzoNobel).

In an embodiment, the amphiphilic antioxidant component comprises at least one amphiphilic antioxidant. By amphiphilic antioxidant is meant a surfactant like compound/molecule having a hydrophilic head that has antioxidant or radical scavenging properties and a hydrophobic tail. In an embodiment, the amphiphilic antioxidant is of a type and in an amount such that it is capable of self assembling into micelles with at least one of the surfactants present in a cleaning composition.

The amphiphilic antioxidant compound/molecule structure can vary provided that it has antioxidant or radical scavenging properties that make it preferentially subject to attack by the oxidant present in the solution in comparison to the surfactant contained in the cleaning solution.

The general structure of the amphiphilic antioxidant compound/molecule is illustrated below, where R1 is the hydrophilic head group and R2 is the hydrophobic tail.

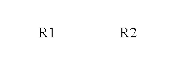

R1 can be selected from any group of polar head configurations also having appropriate radical scavenging capabilities. R1 can be chosen from moieties that are highly polar or hydrophilic, as well as moieties that contain alkyl chains and are less hydrophilic, provided that it provides appropriate radical scavenging functionality to protect or inhibit attack of the surfactant by the oxidant.

In embodiments of the invention, examples of useful structures for R1 are as follows:

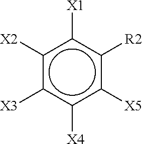

wherein X1 through X5 can be H, OH, CH₃ or any combination thereof. In embodiments of the invention, O may be used to join a CH₃ group to the resonant ring structure. In one embodiment, OH groups are at the X1, X3, and X5 positions.

Or:

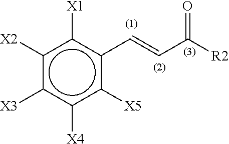

Wherein R1 can also have the configuration previously noted with an extension optionally containing either a double bond between carbons 1 and 2 shown in illustration, or a pendant oxygen attached to the carbon noted at position 3, or combinations of both making up the structure of R1. X1 through X5 can be as described above.

In other embodiments, R1 can include other polar head group configurations exhibiting radical scavenging or antioxidant behavior such as, for example, the following structures:

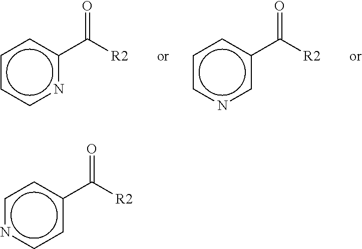

In yet other embodiments, other functional head groups with radical scavenging or antioxidant behavior include hetero-cyclic grouping common to natural vitamins such as Vitamin E, for example, having the following structure:

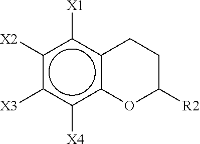

Wherein X1, X2, X3, and X4 can be H, OH, or CH₃ or any combination of those that serve to enable the inhibitory performance of the molecule.

In embodiments of the invention, more than 2 rings may be employed. In embodiments, at least one ring can be a resonant structure. In embodiments of the invention, rings may be 6 member or 5 member rings, with complete saturation or un-saturation up to resonant structures (e.g., benzene ring).

In other embodiments, R1 can have a structure of the active end of Vitamin K1, for example, the following structure:

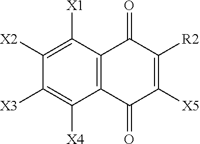

Wherein X1, X2, X3, X4 and X5 can be H, O, CH₃, or any combination thereof.

In yet other embodiments, R1 can have a polar structure found in Lipoic acid, for example, the following structure:

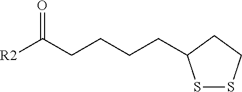

Or R1 can have a structure found in Ascorbic acid, or Vitamin C, for example, the following structure:

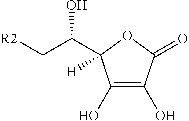

In embodiments of the invention, the gallate moeity is another example of a functional group that can act as both hydrophilic head group and antioxidant structure, for example, the following structure:

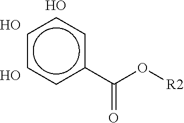

Or the following structure:

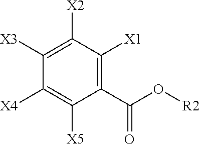

Wherein X1, X2, X3, X4 and X5 can be H, O, CH₃ or any combination thereof.

The previous description and listing of types of functional groups that can fulfill the requirement of the invention for the hydrophilic head group with antioxidant properties R1 is merely exemplary and not intended to limit the scope of the invention. It will be appreciated by one skilled in the art that other structures than those listed can fill the intended role described for the head group of the invention.

In embodiments of the invention, the R2 group or hydrophobic tail, can include a variety of configurations from a simple straight aliphatic chain to a complex branched configuration with an occasional double bond, which does not significantly decrease the overall level of hydrophobicity.

In embodiments of the invention, R2 can be a structure having a number of carbon atoms in the range of from C4 to C20, or C4 to C16, or C6 to C14.

Some non-limiting examples for R2 include the following:

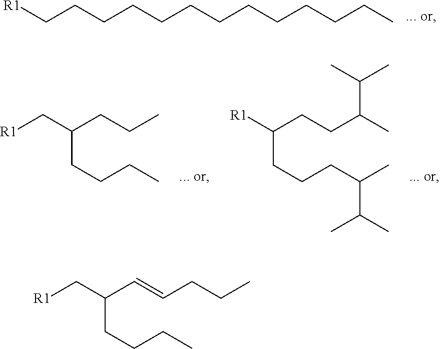

It will be appreciated by one skilled in the art that there are other structures or configurations that can be used for the R2 hydrophobic tail.

In one embodiment, the amphiphilic (or surfactant like) molecule(s) can be selected from naturally occurring compounds such as those found in plants and animal tissues. Examples of such compounds can include compounds, families of compounds and classes of compounds that include catechols, catachins, flavanoids, flavanols, or tannins. Additional examples include ubiquinol, co-enzyme Q-12 and Q-10, uric acid, methionine, glutathione, thymol, carvacrol, eugenol, plus water soluble and fat soluble vitamins.

In one embodiment, the amphiphilic antioxidant is alpha-tocopherol or its derivatives. In another embodiment, the amphiphilic antioxidant component comprises at least two amphiphilic antioxidants, wherein alpha-tocopherol is the primary (i.e., majority) amphiphilic antioxidant. In other embodiments, the amphiphilic antioxidant can be chosen from beta, delta or gamma-tocopherol, their respective derivatives, and combinations thereof, or in combination with alpha-tocopherol or its derivatives.

In one embodiment of the invention, the amphiphilic antioxidant component comprises at least one amphiphilic antioxidant and at least one antioxidant booster, wherein the molar ratio of amphiphilic antioxidant to antioxidant booster is at least 1:1. In an embodiment, the antioxidant booster includes at least one hydrophilic compound having antioxidant or radical scavenging properties. In embodiments, the ratio of amphiphilic antioxidant to antioxidant booster is at least 2:1, or at least 3:1, or at least 5:1, based on the weight of the materials. In embodiments of the invention, the antioxidant booster includes a hydrophilic organic compound having a structure as illustrated below:

R₃-R₄

wherein R₃ is a 5 or 6 member ring; wherein the members of the 6 member ring are all C or optionally where one ring member is N, and wherein one C has —R₄ as a substituent and the other carbon ring members can have a substituent group selected from —H, —OH, —OCH₃; and wherein the members of the 5 member ring are all C or optionally where up to 2 ring members are S, and wherein one C has —R₄ as a substituent and the other ring members only have —H as a substituent; and
wherein R₄ is a carbon chain having a length from C1 to C5 and at least one carboxylic acid functional group. In one embodiment, R₄ has one carboxylic acid functional group that is a terminal group on the chain.

In one embodiment, the antioxidant booster having the formula above has a carbon chain tail having a length of C1-C5, contains a total of 6-10 carbon atoms and a total of 2-6 oxygen atoms, and has a molecular weight in the range from 120-225 g/mol.

In one embodiment, the antioxidant booster is chosen from lipoic acid, caffeic acid, cinnamic acid, nicotinic acid, picolinic acid, ferulic acid, coumaric acid, derivatives thereof, and combinations thereof.

In addition, combinations of the above mentioned amphiphilic (or surfactant like) molecules can be included in the amphiphilic antioxidant component. In one embodiment, the amphiphilic antioxidant component comprises alpha-tocophol (as amphiphilic antioxidant) and picolinic acid (as antioxidant booster). In one embodiment, the alpha-tocopherol is present in an amount from about 0.5 to about 20 wt %, based on the amount of surfactant, and picolinic acid is present in an amount from about 0.5 to about 20 wt %, based on the amount of alpha-tocopherol. In one embodiment, the alpha-tocopherol is present in an amount from about 1.0 to about 10 wt %, based on the amount of surfactant, and the lipoic acid is present in an amount from about 1.0 to about 10 wt %, based on the amount of alpha-tocopherol. In an embodiment, the alpha-tocopherol is present in an amount from about 1.5 to about 6 wt % based on the amount of surfactant, and the picolinic acid is present in an amount from about 1.5 to 6 wt %, based on the amount of alpha-tocopherol.

Certain optional constituents which can be present in the inventive compositions/formulations are pH adjusting agents and/or pH buffers. Such pH buffers include many materials which are known to the art and which are conventionally used in hard surface cleaning and/or hard surface disinfecting compositions. By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. When present, the pH adjusting agent, and/or pH buffers are present in an amount effective in order to maintain the pH of the inventive composition within a target pH range.

Examples of suitable builders include sodium chloride, EDTA, GLDA and various biodegradable chelating agents. In one embodiment, the builders are selected from the group consisting of organic and inorganic salts. In embodiments, builders can include sodium chloride and a biodegradable chelate, such as GL-38S (from AkzoNobel).

In embodiments of the invention, the solution (or composition) containing the amphiphilic antioxidant component in accordance with the invention contains less than 0.05 wt %, or less than 0.025 wt %, or is free from an organic acid peroxide precursor.

The examples set forth below are for the purpose of illustration and to describe embodiments of the best mode of the invention at the present time. The scope of the invention is not in any way limited by the examples set forth below.

### EXAMPLES

The following examples have been carried out to illustrate preferred embodiments of the invention. These examples include the preparation of cleaning solutions and stability tests conducted on the test solutions.

All formulations have been made with deionized water at room temperature using a magnetic mixer and stir bars. The “% stability” is defined as the percentage of hydrogen peroxide remaining after the described stress test. Both 16 hours at 96° C. and 24 hours at 94° C. simulate the behavior that can be expected of these formulations after one year at room temperature. The test utilizing 7 days at 94° C. is particularly harsh and indicative of the robustness of the invention.

### Comparative Example 1

A cleaning formulation was prepared as follows: A 250 ml beaker was charged with 84 grams of deionized water and 5 grams of a nonionic/cationic surfactant blend (Berol® 226SA) was added under constant mixing. To this mixture was added 10 grams of a stabilized hydrogen peroxide, stabilized with a phosphonate stabilizer (Peroxy-Blend® PB33), also under constant mixing. Caustic was added to bring the mixture to a pH of 7. A small amount of deionized water was added at the end to bring the total to 100 grams. The resulting aqueous cleaning formulation contained about 5 wt % surfactant blend, about 3.3 wt % hydrogen peroxide and about 0.05% to about 1% phosphonate stabilizer.

### Comparative Example 2

A second cleaning formulation was prepared in a similar manner to comparative example 1, except technical grade hydrogen peroxide (35 wt %) was used as the source of the hydrogen peroxide. The resulting aqueous cleaning formulation contained about 5 wt % surfactant blend and about 3.5 wt % hydrogen peroxide.

### Example 1

A cleaning formulation was prepared in a similar manner to comparative example 1, except an amphiphilic antioxidant and antioxidant booster blend, consisting of alpha tocopherol/lipoic acid in a ratio 1909:91 ppm, based on the total cleaning formulation, was added prior to adjusting to a pH of 7 (with caustic).

### Example 2

A cleaning formulation was prepared in a similar manner to comparative example 2, except an amphiphilic antioxidant and antioxidant booster blend, consisting of alpha tocopherol/lipoic acid in a ratio 1909:91 ppm, based on the total cleaning formulation, was added prior to adjusting to a pH of 7 (with caustic).

### Example 3

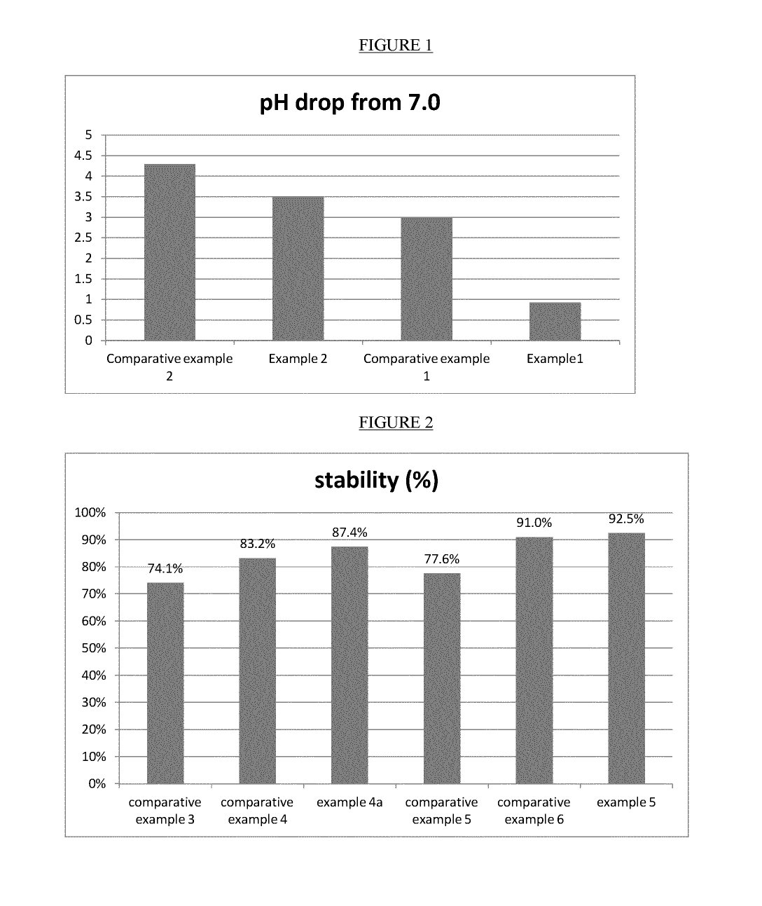

The cleaning formulations according to comparative examples 1 and 2, and examples 1 and 2, were each subjected to elevated temperature aging for 24 hours at 94° C. and then measured for change in pH. The results are shown below in Table 1 and FIG. 1.

TABLE 1
Elevated temperature aging.

| Cleaning Formulation | pH Change from 7 |
|---|---|
| Comp. Ex. 2 | −4.3 |
| Ex. 2 | −3.5 |
| Comp. Ex. 1 | −3.0 |
| Ex. 1 | −0.93 |

A review of table 1 and FIG. 1 reveals that adding the amphiphilic antioxidant and antioxidant booster blend reduces the pH drop. The presence of the phosphonate stabilizer also contributed to reducing the pH drop. The best result is seen from the synergistic combination of both the amphiphilic antoxidant/booster package and the phosphonate stabilizer.

### Comparative Example 3

A cleaning formulation was prepared as follows: A 250 ml beaker was charged with 30 grams of deionized water and 55 grams of a stabilized hydrogen peroxide, stabilized with a phosphonate stabilizer (Peroxy-Blend® PB31), was added under constant mixing. To this mixture was added 7 grams of a nonionic surfactant (Berol® 508) also under constant mixing. Caustic was added to bring the mixture to a pH of 4. A small amount of deionized water was added at the end to bring the total to 100 grams. This solution was then diluted 1:7 with deionized water and then caustic was added to bring the pH to 7. The resulting aqueous cleaning formulation contained about 1 wt % surfactant blend, about 2.5% hydrogen peroxide and about 0.05% to about 1% phosphonate stabilizer.

### Comparative Example 4

A cleaning formulation was prepared in a similar manner to comparative example 3, except that 400 ppm of BHT (Butylated Hydroxytoluene) was added based on the 1 in 7 diluted formulation prior to adjusting to a pH of 7.

### Example 4

A cleaning formulation was prepared in a similar manner to comparative example 3, except that an amphiphilic antioxidant and antioxidant booster blend, consisting of alpha tocopherol/caffeic acid in a ratio of 384:16 ppm, was added based on the 1 in 7 diluted formulation prior to adjusting to a pH of 7.

### Comparative Example 5

A cleaning formulation was prepared as follows: A 250 ml beaker was charged with 30 grams of deionized water and 55 grams of a stabilized hydrogen peroxide, stabilized with a phosphonate stabilizer (Peroxy-Blend® PB31), was added under constant mixing. To this mixture was added 7 grams of a nonionic surfactant (Berol® 508) and 3 grams of an anionic surfactant (NAS-8), also under constant mixing. Caustic was added to bring the mixture to a pH of 4. A small amount of deionized water was added at the end to bring the total to 100 grams. This solution was then diluted 1:7 with deionized water and then caustic was added to bring the pH to 7. The resulting aqueous cleaning formulation contained about 1 wt % nonionic surfactant, about 0.43% anionic surfactant, about 2.5% hydrogen peroxide and about 0.05% to about 1% phosphonate stabilizer.

### Comparative Example 6

A cleaning formulation was prepared in a similar manner to comparative example 5, except that 400 ppm of BHT (Butylated Hydroxytoluene) was added based on the 1 in 7 diluted formulation prior to adjusting to a pH of 7.

### Example 5

A cleaning formulation was prepared in a similar manner to comparative example 5, except that an amphiphilic antioxidant and antioxidant booster blend, consisting of alpha tocopherol/caffeic acid in a ratio of 384:16 ppm, was added based on the 1 in 7 diluted formulation prior to adjusting to a pH of 7.

### Example 6

Various combinations of the above formulations with additives were measured for turbidity and hydrogen peroxide stability after being subjected to accelerated aging for 7 days at 94° C. The results for turbidity and stability are shown in Table 2. The results for stability are also shown graphically in FIG. 2.

TABLE 2
accelerated turbidity and stability testing.

| Cleaning Formulation | Turbidity (FAU) | % Stability |
|---|---|---|
| Comp. Ex. 3 | 825 | 74.1 |
| Comp. Ex. 4 | 45 | 83.2 |
| Ex. 4 | 3 | 87.4 |
| Comp. Ex. 5 | 772 | 77.6 |
| Comp. Ex. 6 | 65 | 91 |
| Ex. 5 | 4 | 92.5 |

A review of Table 2 and FIG. 2 reveals that the cleaning formulations according to the invention out-perform the formulations with BHT added.

### Comparative Example 7

A cleaning formulation was prepared as follows: A 250 ml beaker was charged with 30 grams of deionized water and 55 grams of a stabilized hydrogen peroxide, stabilized with a phosphonate stabilizer (Peroxy-Blend® PB31), was added under constant mixing. To this mixture was added 7 grams of a nonionic surfactant (Berol® 508) also under constant mixing. Caustic was added to bring the mixture to a pH of 4. A small amount of deionized water was added at the end to bring the total to 100 grams. This solution was then diluted 1:7 with deionized water and then caustic was added to bring the pH to 7. The resulting aqueous cleaning formulation contained about 1 wt % surfactant blend, about 2.5% hydrogen peroxide and about 0.05% to about 1% phosphonate stabilizer.

### Comparative Example 8

A cleaning formulation was prepared in a similar manner to comparative example 7, except that 13 ppm of cinnamic acid was added based on the diluted solution containing 1% nonionic surfactant, about 2.5% hydrogen peroxide and about 0.05% to 1% phosphonate stabilizer.

### Comparative Example 9

A cleaning formulation was prepared in a similar manner to comparative example 7, except that 16 ppm of caffeic acid was added based on the diluted solution containing 1% nonionic surfactant, about 2.5% hydrogen peroxide and about 0.05% to 1% phosphonate stabilizer.

### Example 7

A cleaning formulation was prepared in a similar manner to comparative example 7, except that 400 ppm of alpha tocopherol was added based on the diluted solution containing 1% nonionic surfactant, about 2.5% hydrogen peroxide and about 0.05% to 1% phosphonate stabilizer.

### Example 8

A cleaning formulation was prepared in a similar manner to comparative example 7, except that an amphiphilic antioxidant and antioxidant booster blend, consisting of alpha tocopherol/cinnamic acid in a ratio of 387:13 ppm, was added based on the diluted solution containing 1% nonionic surfactant, about 2.5% hydrogen peroxide and about 0.05% to 1% phosphonate stabilizer.

### Example 9

A cleaning formulation was prepared in a similar manner to comparative example 7, except that an amphiphilic antioxidant and antioxidant booster blend, consisting of alpha tocopherol/caffeic acid in a ratio of 384:16 ppm, was added based on the diluted solution containing 1% nonionic surfactant, about 2.5% hydrogen peroxide and about 0.05% to 1% phosphonate stabilizer.

### Example 10

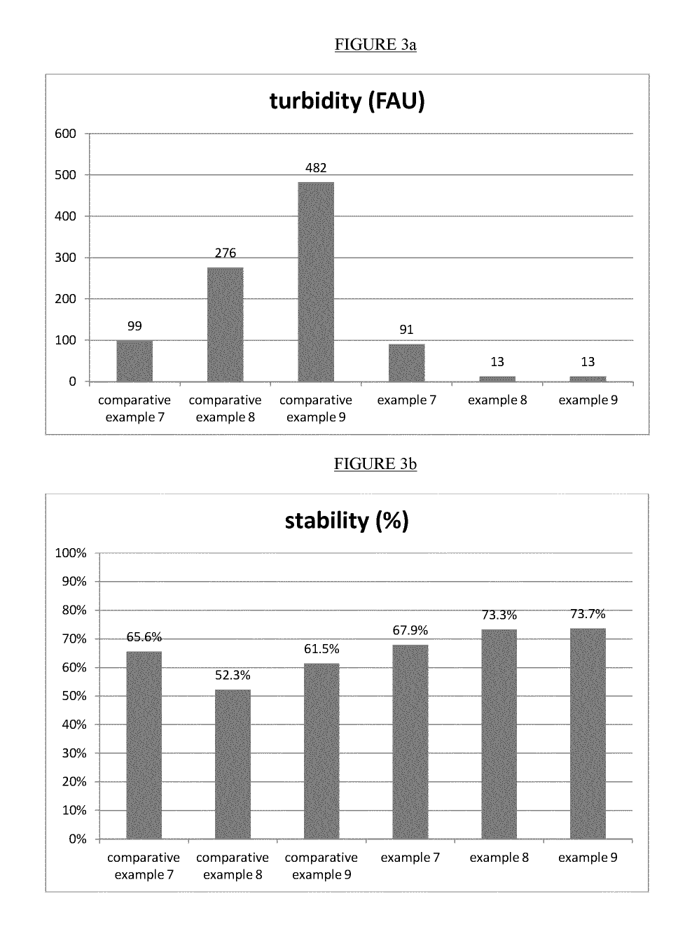

Various formulations above were measured for turbidity and hydrogen peroxide stability after being subjected to accelerated aging for 7 days at 94° C. The results are shown in Table 3, and FIGS. 3a and 3b.

TABLE 3
accelerated turbidity and stability testing.

| Cleaning Formulation | Turbidity (FAU) | % Stability |
|---|---|---|
| Comp. Ex. 7 | 99 | 65.6 |
| Comp. Ex. 8 | 276 | 52.3 |
| Comp. Ex. 9 | 482 | 61.5 |
| Ex. 7 | 91 | 67.9 |
| Ex. 8 | 13 | 73.3 |
| Ex. 9 | 13 | 73.7 |

A review of table 3 and FIGS. 3a and 3b reveals that there is a synergistic effect from combining the polyphenol antioxidants with the amphiphilic alpha tocopherol (vitamin E) antioxidant.

### Comparative Example 10

A cleaning formulation was prepared as follows: A 250 ml beaker was charged with 84 grams of deionized water and 5 grams of a nonionic/cationic surfactant blend (Berol® 226SA) was added under constant mixing. To this mixture was added 10 grams of a stabilized hydrogen peroxide, stabilized with a phosphonate stabilizer (Peroxy-Blend® PB33), also under constant mixing. Caustic was added to bring the mixture to a pH of 7. A small amount of deionized water was added at the end to bring the total to 100 grams. The resulting aqueous cleaning formulation contained about 5 wt % surfactant blend, about 3.3 wt % hydrogen peroxide, and about 0.05% to about 1% phosphonate stabilizer.

### Example 11

A cleaning formulation was prepared in a similar manner to comparative example 10, except an amphiphilic antioxidant and antioxidant booster blend, consisting of alpha tocopherol/cinnamic acid in a ratio 1966:34 ppm, based on the total cleaning formulation, was added prior to adjusting to a pH of 7 (with caustic).

### Example 12

A cleaning formulation was prepared in a similar manner to comparative example 10, except an amphiphilic antioxidant and antioxidant booster blend, consisting of alpha tocopherol/caffeic acid in a ratio 1959:41 ppm, based on the total cleaning formulation, was added prior to adjusting to a pH of 7 (with caustic).

### Example 13

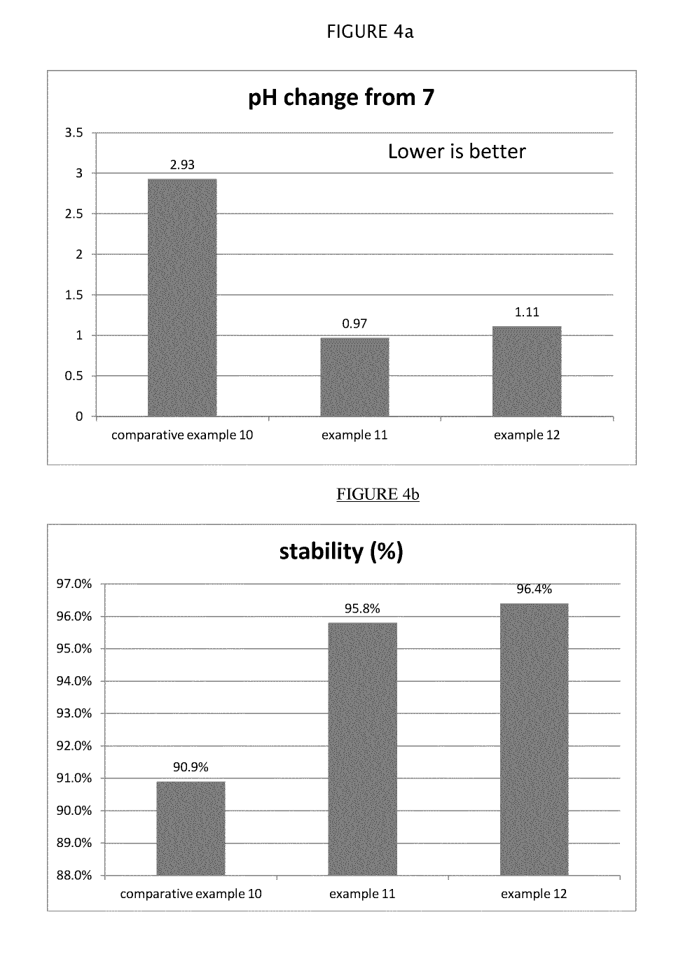

The cleaning formulations according to comparative example 10, and examples 11 and 12, were each subjected to elevated temperature aging for 24 hours at 94° C. and then measured for change in pH and hydrogen peroxide stability. The results are shown below in Table 4 and FIGS. 4a and 4b.

TABLE 4
pH change and stability testing.

| Cleaning Formulation | pH Change from 7 | % Stability |
|---|---|---|
| Comp. Ex. 10 | −2.93 | 90.9 |
| Ex. 11 | −0.97 | 95.8 |
| Ex. 12 | −1.11 | 96.4 |

A review of table 4 and FIGS. 4a and 4b reveals that the cleaning formulations according to the invention results in a very positive impact on both the change in pH (much less) and the hydrogen peroxide stability (more left after stress). In addition to being effective for both nonionic and nonionic/anionic surfactant systems, the invention is effective on nonionic/cationic systems as well.

### Example 14

Cleaning performance was evaluated for cleaning solutions according to the invention by subjecting the cleaning solutions of the invention and a control cleaning solution to accelerated aging and testing for any change in cleaning performance. A starting solution for all test samples was prepared similar to comparative example 1 that contained 5% Berol® 226SA and 10% Peroxy-Blend® PB33, which was adjusted with caustic to a pH of 9.5.

The control was prepared by diluting the starting solution with water 1:5 giving a cleaning solution with 1% surfactant and then adjusting the pH to 7. A pH of 7 was chosen to provide a more aggressive challenge to the stability of the system.

Test samples were prepared by adding a 2000 ppm dose of a 10:1 ratio mixture of alpha-tocopherol and picolinic acid to the starting solution (Test Sample 1) and by adding a 2000 ppm dose of a 1500:500:100 mixture of alpha-tocopherol, lecithin and picolinic acid to the starting solution (Test Sample 2). Both test solutions were diluted and the pH was adjusted to 7, similar to the control.

Cleaning performance was tested as follows: accelerated aging was for 24 hours at 94° C., the test solutions were diluted 1:5 (as discussed above) before and after accelerated aging to make pour-down solutions, the pour down solutions were poured over train-engine grease on white painted steel panels, and surface reflectivity was measured using a brightness meter. ASTM D-4488 definition of cleaning efficiency was applied to evaluate the performance.

The change in pH was measure before and after the accelerated aging. The results are shown in FIG. 5. A review of FIG. 5 reveals that the pH dropped much more for the control compared to Test Samples 1 and 2.

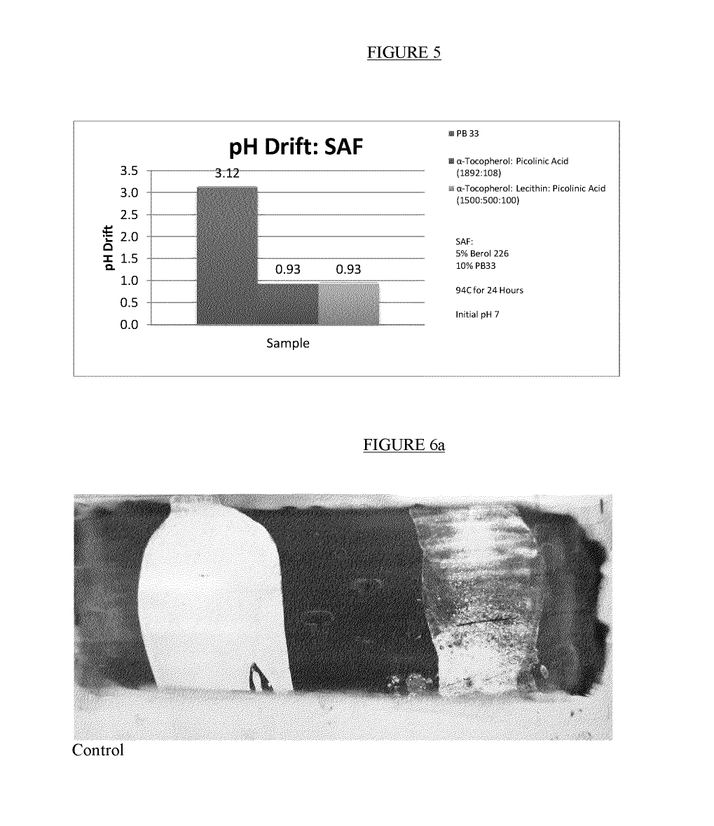

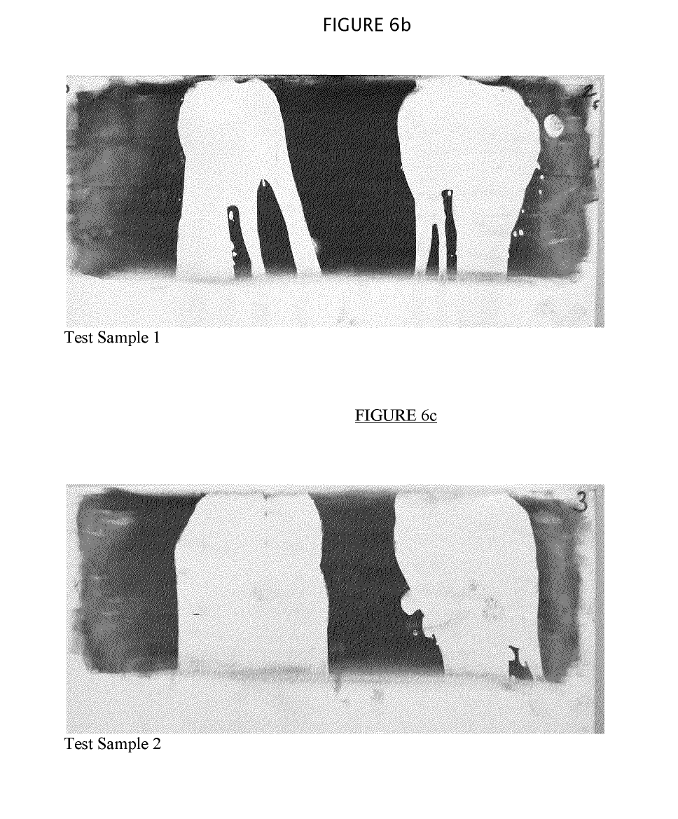

The results of the pour down testing is shown in FIGS. 6a-6c. The test before aging is shown on the left and after aging on the right for each of the figures. A review of the figures reveals that the control did not effectively remove the grease after accelerated aging. In contrast, both Test Samples 1 and 2 were still effective after accelerated aging.

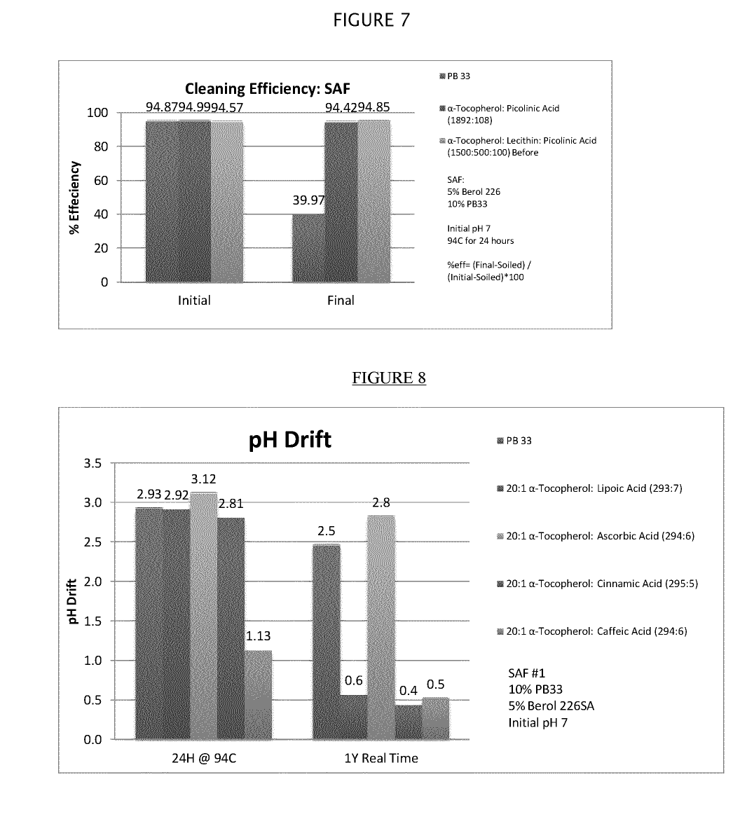

The quantified cleaning test results according to ASTM D-4488 are shown in FIG. 7. A review of FIG. 7 reveals that the control significantly reduced in cleaning ability, while Test Samples 1 and 2 maintained cleaning ability after accelerated aging.

### Example 15

A cleaning formulation having a nonionic/cationic surfactant blend was prepared in a similar manner to comparative example 1, except that it was not diluted. The formulation contained 5% Berol® 226SA and 10% Peroxy-Blend® PB33, which was adjusted with caustic to a pH of 7 (PB 33 formulation). Four additional test formulations were prepared, similar to above, except different blends of alpha tocopherol and different hydrophilic antioxidants (at a 20:1 molar ratio of alpha tocopherol:hydrophilic antioxidant) were added in each test formulation prior to adjusting to a pH of 7. The added blends were as follows: 1) alpha tocopherol:lipoic acid in a ratio 293:7 ppm; 2) alpha tocopherol:ascorbic acid in a ratio 294:6 ppm; 3) alpha tocopherol:cinnamic acid in a ratio 295:5 ppm; and 4) alpha tocopherol:caffeic acid in a ratio 294:6 ppm; all based on the total cleaning formulation.

The cleaning formulations were each subjected to elevated temperature aging for 24 hours at 94° C. and for 1 year at ambient temperature (an average temperature of approximately 20° C.) and then measured for change in pH. The results are shown below in FIG. 8.

A review of FIG. 8 reveals that adding the alpha tocopherol and antioxidant booster blend according to the invention significantly reduces the pH drop for real time aging.

### Example 16

A cleaning formulation having a nonionic surfactant was prepared in a similar manner to comparative example 1, except that the formulation contained 7% Berol® 508 and 54% Peroxy-Blend® PB31, which was adjusted with caustic to a pH of 7 and then diluted with water 1:7 to have a final surfactant concentration of about 1% (PBX formulation). Five additional test formulations were prepared, similar to above, except different antioxidants and blends of antioxidants were added in each test formulation prior to adjusting to a pH of 7 and dilution with water. The added alpha tocopherol:booster blends were as follows: 1) 400 ppm alpha tocopherol; 2) alpha tocopherol:cinnamic acid in a ratio 387:13 ppm; 3) alpha tocopherol:caffeic acid in a/aniointio 384:16 ppm; and 4) 13 ppm cinnamic acid; and 5) 16 ppm caffeic acid; all based on the total cleaning formulation.

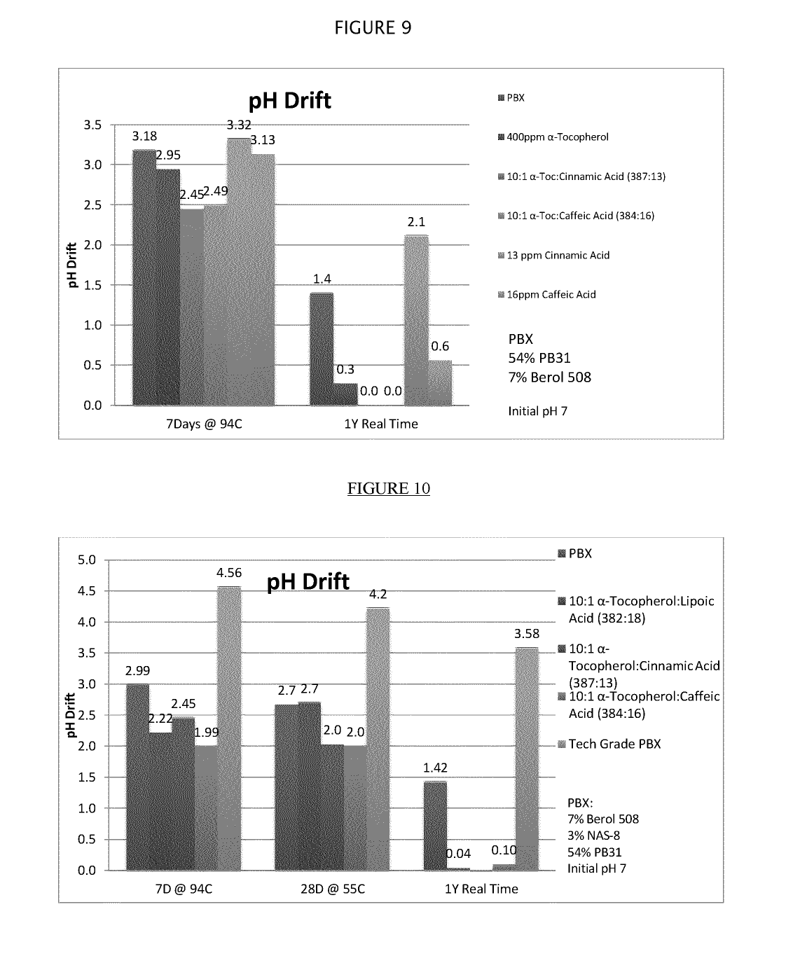

The cleaning formulations were each subjected to elevated temperature aging for 24 hours at 94° C. and for 1 year at ambient temperature (an average temperature of approximately 20° C.) and then measured for change in pH. The results are shown below in FIG. 9.

A review of FIG. 9 reveals that adding the alpha tocopherol and antioxidant booster blend according to the invention (i.e., blends 2) and 3) described above) showed synergistic improvement in preventing pH drop.

### Example 17

A cleaning formulation having a nonionic/anionic surfactant blend was prepared in a similar manner to example 16, except that the formulation contained 7% Berol® 508, 3% NAS-8 and 54% Peroxy-Blend® PB31, which was adjusted with caustic to a pH of 7 and then diluted with water 1:7 to have a final surfactant concentration of about 1.4% (PBX formulation). Three additional test formulations were prepared, similar to above, except different blends of alpha tocopherol and antioxidant boosters were added in each test formulation prior to adjusting to a pH of 7 and dilution with water. The added blends were as follows: 1) alpha tocopherol:lipoic acid in a ratio 382:18 ppm; 2) alpha tocopherol:cinnamic acid in a ratio 387:13 ppm; and 3) alpha tocopherol:caffeic acid in a ratio 384:16 ppm; all based on the total cleaning formulation. Another test formulation was prepared as above for the PBX formulation, except technical grade hydrogen peroxide was used instead of the Peroxy-Blend® PB31.

The cleaning formulations were each subjected to elevated temperature aging for 7 days at 94° C., 28 days at 55° C., and for 1 year at ambient temperature (an average temperature of approximately 20° C.) and then measured for change in pH. The results are shown below in FIG. 10.

A review of FIG. 10 reveals that adding the alpha tocopherol and antioxidant booster blend according to the invention (i.e., blends 1-3 described above) showed significant improvement in preventing pH drop and technical grade peroxide resulted in much a greater pH drift than the PB31 peroxide.

Thus, while there has been disclosed what is presently believed to be the preferred embodiments of the invention, those skilled in the art will appreciate that other and further changes and modifications can be made without departing from the scope or spirit of the invention, and it is intended that all such other changes and modifications are included within the scope of the invention.

1.-20. (canceled)

21. A composition comprising:
a) an amphiphilic antioxidant component,
b) a surfactant component, and
c) an oxidant component,
wherein the amphiphilic antioxidant component comprises at least one amphiphilic antioxidant and at least one hydrophilic antioxidant booster, wherein the molar ratio of amphiphilic antioxidant:booster is at least 1:1,
wherein the surfactant component comprises at least one organic surfactant,
wherein said oxidant component comprises at least one oxidant, and
wherein the amphiphilic antioxidant component is present in an amount sufficient to improve the stability of the surfactant against oxidative attack.

22. The composition according to claim 21, wherein said oxidant component comprises a peroxide and a phosphonic acid based sequestering agent.

23. The composition according to claim 21, wherein the amphiphilic antioxidant is a compound having the formula: R1-R2;
Wherein R1 is a functional group chosen from the following: 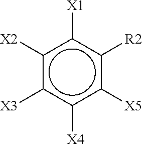
wherein X1 through X5 can be H, OH, CH₃ or any combination thereof, or optionally, can be O that joins a CH₃ group to the resonant ring structure; or, 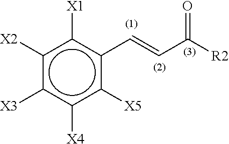
Wherein R1 contains either a double bond between carbons (1) and (2), or a pendant oxygen attached to carbon (3), or a combination of both; and wherein X1 through X5 are as described above; or, 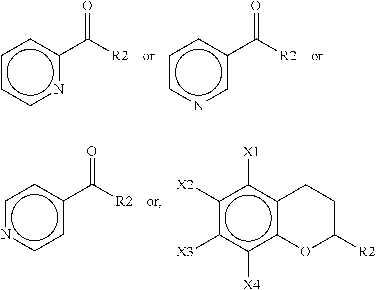
wherein X1, X2, X3, and X4 can be H, OH, or CH₃ or any combination of thereof; or, 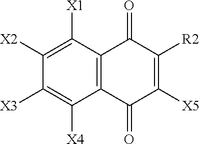
wherein X1, X2, X3, X4 and X5 can be H, O, CH₃, or a combination thereof; or, 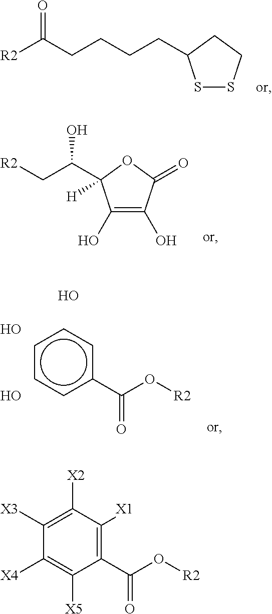
wherein X1, X2, X3, X4 and X5 can be H, O, CH₃ or a combination thereof; and
wherein R2 is a straight or branched carbon chain hydrophobic structure having a number of carbon atoms in the range of from C4 to C20.

24. The composition according to claim 23, wherein compounds having R1 formulas containing X1-X5 have OH groups at each of the X1, X3, and X5 positions.

25. The composition according to claim 21, wherein the surfactant component comprises a non-ionic surfactant which comprises one or more of ethoxylated and/or propoxylated fatty acid, alcohol, amine or amide, having from 1 to 12 mols of ethylene oxide and/or propylene oxide per mol of acid, alcohol, amine or amide; and wherein the acid, alcohol, amine or amide comprises from 7 to 15 carbon atoms.

26. The composition according to claim 21, wherein the surfactant component comprises a cationic surfactant.

27. The composition according to claim 26, wherein the cationic surfactant is a quaternary ammonium compound.

28. The composition according to claim 21, wherein the antioxidant booster is at least one hydrophilic compound having the formula: R3-R4;
wherein R₃ is a 5 or 6 member ring; wherein the members of the 6 member ring are all C or optionally where one ring member is N, and wherein one C has —R₄ as a substituent and the other carbon ring members can have a substituent group selected from —H, —OH, —OCH₃; and wherein the members of the 5 member ring are all C or optionally where up to 2 ring members are S, and wherein one C has —R₄ as a substituent; and
wherein R₄ is a carbon chain having a length from C1 to C5 and at least one carboxylic acid functional group.

29. The composition according to claim 28, wherein R₄ has one carboxylic acid functional group that is a terminal group on the chain.

30. The composition according to claim 28, wherein the antioxidant booster is selected from the group consisting of lipoic acid, caffeic acid, cinnamic acid, nicotinic acid, picolinic acid, ferulic acid, coumaric acid, derivatives thereof, and combinations thereof.

31. The composition according to claim 22, wherein the oxidant component comprises hydrogen peroxide and at least one diphosphonic acid stabilizer.

32. The composition according to claim 31, wherein the oxidant component comprises: (1) hydrogen peroxide in an amount of 0.1 to about 8 wt %, based on the total composition, and (2) HEDP, its salts or degradation products thereof in an amount from about 10 to about 60 wt %, based on the amount of hydrogen peroxide; wherein the surfactant is present in an amount of 0.1 to about 2 wt %, based on the total composition; and wherein the at least one amphiphilic antioxidant compound is alpha-tocopherol and is present in an amount from about 0.5 to about 20 wt %, based on the amount of surfactant.

33. A cleaning composition comprising a composition according to claim 21.

34. An article comprising a substrate, wherein the composition according to claim 21 is absorbed onto or into said substrate.

35. A method for preparing a stabilized solution having an organic surfactant and an oxidant, which comprises: 1) preparing a stabilized surfactant composition by combining a surfactant component with an amphiphilic antioxidant component; 2) combining the stabilized surfactant composition with an oxidant component; 3) and adding an alkali agent to the combination from step 2) in an amount to adjust the pH to a value of at least 6,
wherein the surfactant component comprises said organic surfactant,
wherein the oxidant component comprises said oxidant,
wherein the amphiphilic antioxidant component comprises at least one amphiphilic antioxidant and at least one hydrophilic antioxidant booster, wherein the molar ratio of amphiphilic antioxidant:booster is at least 1:1, and
wherein the amphiphilic antioxidant component is present in an amount sufficient to improve the stability of the surfactant against oxidative attack in the solution containing said oxidant.

36. A method for improving the stability of a solution containing a surfactant and an oxidant, comprising incorporating an amphiphilic antioxidant component in said solution,
wherein the amphiphilic antioxidant component comprises at least one amphiphilic antioxidant and at least one hydrophilic antioxidant booster, wherein the molar ratio of amphiphilic antioxidant:booster is at least 1:1, and
wherein the amphiphilic antioxidant component is present in an amount sufficient to improve the stability of the surfactant against oxidative attack in said solution.

37. The composition according to claim 23, wherein the antioxidant booster is at least one hydrophilic compound having the formula: R3-R4;
wherein R₃ is a 5 or 6 member ring; wherein the members of the 6 member ring are all C or optionally where one ring member is N, and wherein one C has —R₄ as a substituent and the other carbon ring members can have a substituent group selected from —H, —OH, —OCH₃; and wherein the members of the 5 member ring are all C or optionally where up to 2 ring members are S, and wherein one C has —R₄ as a substituent; and
wherein R₄ is a carbon chain having a length from C1 to C5 and at least one carboxylic acid functional group.

38. The composition according to claim 37, wherein the amphiphilic antioxidant component comprises alpha-tocopherol and picolinic acid, wherein the alpha-tocopherol and picolinic acid are each present in an amount from about 1 to about 10 wt %, based on the amount of surfactant.

39. The composition according to claim 38, wherein the oxidant component comprises hydrogen peroxide and at least one diphosphonic acid stabilizer.

40. The composition according to claim 39, wherein the surfactant component comprises a non-ionic surfactant which comprises one or more of ethoxylated and/or propoxylated fatty acid, alcohol, amine or amide, having from 1 to 12 mols of ethylene oxide and/or propylene oxide per mol of acid, alcohol, amine or amide; and wherein the acid, alcohol, amine or amide comprises from 7 to 15 carbon atoms.
